(19) United States
(12) Patent Application Publication
(10) Pub. No.: US 2021/0291875 A1
(43) Pub. Date: Sep. 23, 2021

(54) MANAGEMENT DEVICE, MANAGEMENT METHOD, AND STORAGE MEDIUM

(71) Applicant: HONDA MOTOR CO., LTD., Tokyo (JP)

(72) Inventors: Koichi Ogura, Tokyo (JP); Yusuke Kawada, Wako-shi (JP); Kensaku Yamamoto, Wako-shi (JP); Masahiro Motoyoshi, Tokyo (JP)

(21) Appl. No.: 17/202,387

(22) Filed: Mar. 16, 2021

(30) Foreign Application Priority Data
Mar. 18, 2020 (JP) 2020-047112

(51) Int. Cl. B60W 60/00; B60Q 9/00; G06K 9/00; G06Q 10/02; G06Q 50/30

(52) U.S. Cl. CPC B60W 60/00253; B60W 60/0016; B60Q 9/00; G06K 9/00838; G06K 9/00369; B60W 2540/26; G06Q 10/02; G06Q 50/30; B60W 2540/01; B60W 2540/221; B60W 2540/24; G06K 9/00335

(57) ABSTRACT

A management device that manages a service of transporting a user in a designated section using a vehicle which is able to travel autonomously without a driver by causing the vehicle to travel includes: a user detector configured to detect whether a user in the vehicle has alighted at a scheduled alighting position of the user; and an operation controller configured to cause the vehicle to perform a predetermined operation when the user detector detects that the user has not alighted at the scheduled alighting position.

### CROSS-REFERENCE TO RELATED APPLICATION

Priority is claimed on Japanese Patent Application No. 2020-047112, filed Mar. 18, 2020, the content of which is incorporated herein by reference.

### BACKGROUND

### Field of the Invention

The present invention relates to a management device, a management method, and a storage medium.

### Description of Related Art

A technique for a pickup service using an automated-driving vehicle in which a driver does not ride is disclosed (see Japanese Unexamined Patent Application, First Publication No. 2019-79462).

### SUMMARY

In such a type of service, a person in poor condition, a drunk person, or the like may not (or not be able to) appropriately alight from a vehicle even when the vehicle arrives at a scheduled alighting position. When a user is still in the vehicle, a user who uses the pickup service later may not be able to get in the vehicle.

An aspect of the invention was made in consideration of the aforementioned circumstances and an objective thereof is to provide a management device, a management method, and a storage medium that can appropriately cope with a user who does not alight at a scheduled alighting position.

A management device, a management method, and a storage medium according to the invention employ the following configurations.

(1) According to an aspect of the invention, there is provided a management device that manages a service of transporting a user in a designated section using a vehicle which is able to travel autonomously without a driver by causing the vehicle to travel, the management device including a storage device configured to store a program and a hardware processor, wherein the hardware processor executes the program to perform: receiving a transportation request from a terminal device; detecting whether a user in the vehicle has alighted at a scheduled alighting position of the user; and causing the vehicle to perform a predetermined operation when it is detected that the user has not alighted at the scheduled alighting position.

An aspect of (2) provides the management device according to the aspect of (1), wherein the hardware processor causes the vehicle to perform the predetermined operation when it is detected that the user has not alighted at the scheduled alighting position even if a predetermined time has elapsed after the vehicle has arrived at the scheduled alighting position.

An aspect of (3) provides the management device according to the aspect of (1), further including a notifier configured to create an alarm, wherein the predetermined operation includes creating an alarm to urge the user to alight, and the hardware processor causes the notifier to create an alarm.

An aspect of (4) provides the management device according to the aspect of (1), further including a vibrator configured to vibrate a seat of the vehicle, wherein the predetermined operation includes vibrating the seat to urge the user to alight, and the hardware processor causes the vibrator to vibrate the seat.

An aspect of (5) provides the management device according to the aspect of (1), further including a sound output unit configured to output an announcement for urging the user to alight by voice, wherein the predetermined operation includes outputting the announcement by voice to urge the user to alight, and the hardware processor causes the sound output unit to output the voice of announcement.

An aspect of (6) provides the management device according to the aspect of (1), further including a driver configured to recline a seat of the vehicle, wherein the predetermined operation includes reclining the seat to urge the user to alight, and the hardware processor causes the driver to recline the seat.

An aspect of (7) provides the management device according to the aspect of (1), further including an information notifier configured to notify the user of the vehicle of information, wherein the predetermined operation includes requesting another user to ascertain the condition of the user who has not alighted at the scheduled alighting position, and the hardware processor causes the information notifier to notify the other user of information which is used to request the other user to ascertain the condition of the user who has not alighted at the scheduled alighting position.

An aspect of (8) provides the management device according to the aspect of (1), wherein the predetermined operation includes first moving to a scheduled alighting position of another user riding together in the vehicle and then moving to the scheduled alighting position of the user, and the hardware processor causes the vehicle to first move to the scheduled alighting position of the other user and then to move to the scheduled alighting position of the user.

An aspect of (9) provides the management device according to the aspect of (1), wherein the predetermined operation includes first moving to scheduled alighting positions of all other user riding together in the vehicle and finally moving to the scheduled alighting position of the user, and the hardware processor causes the vehicle to first move to the scheduled alighting positions of all the other users and to finally move to the scheduled alighting position of the user.

An aspect of (10) provides the management device according to the aspect of (1), wherein the predetermined operation includes moving to a predetermined final destination, and the hardware processor causes the vehicle to move to the final destination.

An aspect of (11) provides the management device according to the aspect of (1), further including a condition detector configured to detect the condition of the user, wherein the predetermined operation includes moving to a hospital according to the condition of the user, and the hardware processor causes the vehicle to move the hospital when the condition detector detects that the condition of the user is a predetermined state.

(12) According to another aspect of the invention, there is provided a management method that is performed by a computer, which realizes a management device that manages a service of transporting a user in a designated section using a vehicle which is able to travel autonomously without a driver by causing the vehicle to travel, the management method including: receiving a transportation request from a terminal device; detecting whether a user in the vehicle has alighted at a scheduled alighting position of the user; and causing the vehicle to perform a predetermined operation when it is detected that the user has not alighted at the scheduled alighting position.

(13) According to another aspect of the invention, there is provided a computer-readable non-transitory storage medium having stored a program causing a computer, which for realizes a management device that manages a service of transporting a user in a designated section using a vehicle which is able to travel autonomously without a driver by causing the vehicle to travel, to perform: receiving a transportation request from a terminal device; detecting whether a user in the vehicle has alighted at a scheduled alighting position of the user; and causing the vehicle to perform a predetermined operation when it is detected that the user has not alighted at the scheduled alighting position.

According to the aspects of (1) to (13), it is possible to appropriately cope with a user who does not alight at a scheduled alighting position.

### BRIEF DESCRIPTION OF THE DRAWINGS

FIG. 1 is a diagram illustrating a configuration of a system including a management device;

FIG. 2 is a diagram illustrating a configuration of a vehicle;

FIG. 3 is a diagram illustrating an example of a cabin when the vehicle is seen from above;

FIG. 4 is a diagram illustrating a configuration of a management device;

FIG. 5 is a diagram illustrating an example of details of user information;

FIG. 6 is a diagram illustrating an example of details of transportation request list information;

FIG. 7 is a diagram illustrating an example of details of transportation schedule information;

FIG. 8 is a diagram which is used to describe a predetermined operation associated with an HMI controller, a vibration controller, and a driver controller;

FIG. 9 is a diagram illustrating an example of an image which is used to request another user to check a user's condition;

FIG. 10 is a diagram illustrating an example of a route which is redetermined by a route determiner;

FIG. 11 is a diagram illustrating an example of a route which is redetermined by the route determiner;

FIG. 12 is a flowchart illustrating a flow of a series of processes which are performed by a management device; and

FIG. 13 is a diagram illustrating an example of a route which is redetermined by the route determiner.

### DESCRIPTION OF EMBODIMENTS

Hereinafter, a management device, a management method, and a storage medium according to an embodiment of the present invention will be described with reference to the accompanying drawings. The management device is a device that manages a service of transporting a user in a designated section using a vehicle which is able to travel autonomously by causing the vehicle to travel without a driver riding therein. The designated section is a section which is designated by a user who boards the vehicle or another user.

Overall Configuration

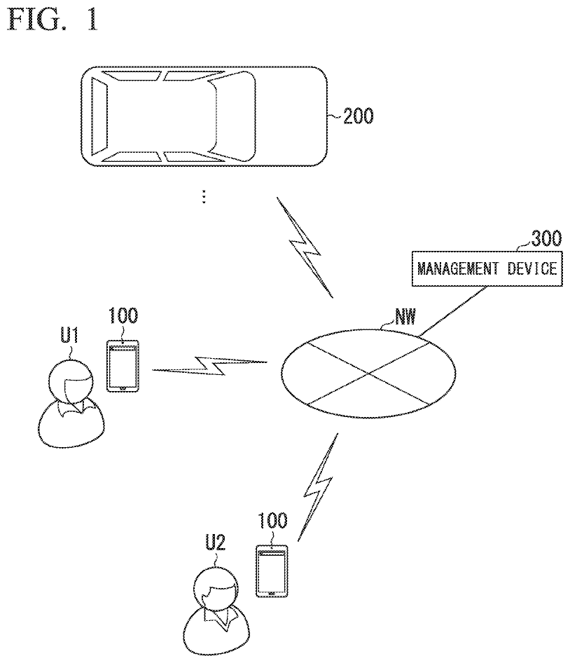

FIG. 1 is a diagram illustrating a configuration of a system including a management device 300. This system includes one or more terminal devices 100 which are used by users, one or more vehicles 200, and a management device 300. These constituents communicate with each other via a network NW. The network NW includes the Internet, a wide area network (WAN), a local area network (LAN), a public circuit line, a provider device, a dedicated circuit line, or a radio base station. A “terminal device which is used by a user” is a terminal device which can be used by a plurality of unspecified persons such as a terminal device in an Internet café and may include a terminal device which is temporarily used by a user. In any case, a “terminal device of a user” refers to, for example, a terminal device for which a user performing operation is specified by a login operation of inputting a password.

Terminal Device

Examples of each terminal device 100 include a smartphone, a tablet terminal, and a personal computer. In the terminal device 100, an application program, a browser, or the like which is used to use the service is started and supports the following service. In the following description, it is assumed that the terminal device 100 is a smartphone and an application program for receiving a service (a vehicle allocation application) is started. The vehicle allocation application communicates with the management device 300 in accordance with a user's operation and transmits a transportation request from the user to the management device 300 or provides information based on information received from the management device 300. A transportation request is electronic information for requesting transportation of a user over a designated section using a vehicle 200. In the example illustrated in FIG. 1, two users including users U1 and U2 are illustrated. In the following description, the users U1 and U2 are referred to as “users U” when they are not distinguished from each other. A user U is a person who causes the terminal device 100 to transmit a transportation request for receiving a service.

A user U may cause the terminal device 100 to transmit a transportation request for receiving a service for another user U (for example, a person (a child or an old) to be protected by the user U) who uses the service along with the user U. In this case, the other user U does not cause a terminal device 100 of the other user U to transmit a transportation request. In this way, there may be various types of users.

Vehicle

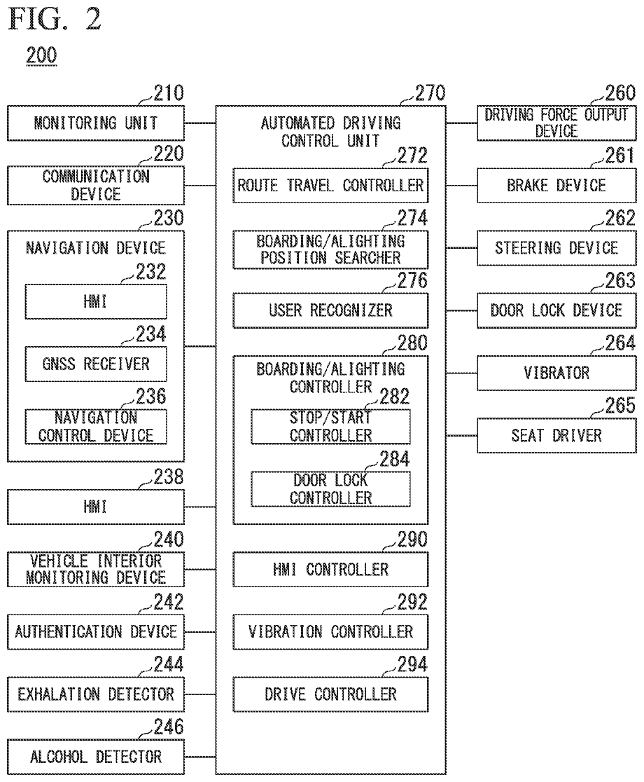

The vehicle 200 is a vehicle including at least a cabin. FIG. 2 is a diagram illustrating a configuration of the vehicle 200. The vehicle 200 includes, for example, a monitoring unit 210, a communication device 220, a navigation device 230, a human-machine interface (HMI) 238, a vehicle interior monitoring device 240, an authentication device 242, an exhalation detector 244, an alcohol detector 246, a driving force output device 260, a brake device 261, a steering device 262, a door lock device 263, a vibrator 264, a seat driver 265, and an automated driving control unit 270.

The monitoring unit 210 includes, for example, a camera that images a space outside the vehicle 200, a radar or a Light Detection and Ranging (LIDAR) that has a detection range outside the vehicle 200, and an object recognition device that performs a sensor fusion process based on outputs thereof. The monitoring unit 210 estimates a type of an object (particularly, a vehicle, a pedestrian, and a bicycle) near the vehicle 200 and outputs the estimated type of an object to the automated driving control unit 270 along with information of a position and a speed thereof.

The communication device 220 is, for example, a radio communication module that accesses the network NW or communicates directly with another vehicle, a terminal device of a pedestrian, or the like. The communication device 220 performs radio communication based on a standard such as Wi-Fi, a dedicated short range communications (DSRC), or Bluetooth (registered trademark). A plurality of communication devices may be prepared by applications as the communication device 220.

The navigation device 230 includes, for example, a human-machine interface (HMI) 232, a global navigation satellite system (GNSS) receiver 234, and a navigation control device 236. The HMI 232 includes, for example, a touch panel type display device, a speaker, and a microphone. The GNSS receiver 234 measures its own position (a position of the vehicle 200) based on radio waves transmitted from GNSS satellites (for example, GPS satellites). The navigation control device 236 includes, for example, a central processing unit (CPU) and various storage devices and controls the navigation device 230 as a whole. Map information (a navigation map) is stored in the storage device. The navigation map is a map in which roads are expressed by nodes and links. The navigation device 230 uploads position information indicating the measured position to the management device 300 using the communication device 220. Uploading of the position information is periodically performed, for example, at intervals of millimeter seconds to seconds.

The HMI 238 is an interface device that transmits and receives information to and from a user inside or outside the cabin. The HMI 238 includes, for example, input and output interfaces such as a speaker, a touch panel, buttons, a mouse, and a keyboard.

The vehicle interior monitoring device 240 includes, for example, a camera or an infrared sensor that images a space in the cabin. An image captured by the camera (hereinafter referred to as a vehicle interior image) may be uploaded to the management device 300 by the communication device 220.

The vehicle interior monitoring device 240 detects whether a user in the vehicle 200 has alighted at a position at which the user is scheduled to alight from the vehicle 200 (hereinafter referred to as a scheduled alighting position) based on the vehicle interior image. The vehicle interior monitoring device 240 identifies a user in the cabin, for example, by performing an image recognition process on the vehicle interior image. The vehicle interior monitoring device 240 detects that a user who is scheduled to alight has alighted at the scheduled alighting position based on the result of identification. In the process of detecting whether a user has alighted, the vehicle interior monitoring device 240 is an example of a “user detector.”

The vehicle interior monitoring device 240 may determine whether a user has alighted at a scheduled alighting position when a predetermined time (for example, several tens of seconds to several tens of minutes) has elapsed after the vehicle 200 has arrived at the scheduled alighting position. In the following description, it is assumed that the vehicle interior monitoring device 240 performs a detection process when a predetermined has elapsed after the vehicle 200 has arrived at the scheduled alighting position.

The authentication device 242 is a device that ascertains whether a user who is going to board the vehicle 200 is an authorized user (that authenticates a user). An authorized user refers to a user which is determined to board the vehicle in cooperation with the management device 300. The authentication device 242 may be an arbitrary device as long as it has an authentication function, such as a short-range radio communication device, a biometric authentication device, or a password input device. The authentication device 242 outputs an authentication result to the automated driving control unit 270.

The exhalation detector 244 detects alcohol included in exhaled air of a user in the vehicle 200 and detects whether the user is drunken. For example, the exhalation detector 244 detects an amount of alcohol included in a unit amount of (for example, 1 [l]) exhaled air of the user and determines whether the amount of alcohol is equal to or greater than a first threshold value (for example, about 0.5 [mg]/[l] to 1 [mg]/[l]) The exhalation detector 244 determines that the user in the vehicle 200 is in a drunken state when it is determined that the amount of alcohol is equal to or greater than the first threshold value, and determines that the user in the vehicle 200 is not in the drunken state when it is determined that the amount of alcohol is less than the first threshold value.

The exhalation detector 244 determines whether the amount of alcohol is greater than a second threshold value (for example, about 1 [mg]/[l]). When it is determined that the amount of alcohol is greater than the second threshold value, the exhalation detector 244 determines that the user in the vehicle 200 is in a state (condition) in which an immediate countermeasure is necessary such as a drunken state or a comatose state.

The alcohol detector 246 detects an amount of alcohol included in blood of a user in terms of a blood alcohol content by coming into contact with a part of the user in the vehicle 200 in which a skin is exposed, and determines whether the user is in the drunken state. The alcohol detector 246 determines, for example, when the alcohol content of the user is equal to or greater than a third threshold value (for example, about 1 [mg]/[ml] to 2 [mg]/[ml]). The alcohol detector 246 determines that the user in the vehicle 200 is in the drunken state when it is determined that the alcohol content is equal to or greater than the third threshold value, and determines that the user in the vehicle 200 is not in the drunken state when it is determined that the alcohol content is less than the third threshold value.

The alcohol detector 246 determines whether the blood alcohol content is greater than a fourth threshold value (for example, about 2 [mg]/[ml]). When it is determined that the alcohol content is greater than the fourth threshold value, the alcohol detector 246 determines that the user in the vehicle 200 is in a state (condition) in which an immediate countermeasure is necessary such as a drunken state or a comatose state.

The exhalation detector 244 and the alcohol detector 246 are examples of a “detector configured to detect the condition of a user.” The vehicle 200 may include at least one of the exhalation detector 244 and the alcohol detector 246. When the vehicle interior monitoring device 240 includes an infrared camera and it can be detected whether a user is in a drunken state using a vehicle interior image which is expressed by thermography, the vehicle 200 may not include the exhalation detector 244 and the alcohol detector 246.

The driving force output device 260 outputs a travel driving force (a torque) for allowing a vehicle to travel to driving wheels. The driving force output device 260 includes, for example, a combination of an internal combustion engine, an electric motor, and a transmission and a power ECU that controls them. The power ECU controls the constituents based on information input from the automated driving control unit 270 or information input from a driving operator which is not illustrated.

The brake device 261 includes, for example, a brake caliper, a cylinder that transmits a hydraulic pressure to the brake caliper, an electric motor that generates a hydraulic pressure in the cylinder, and a brake ECU. The brake ECU controls the electric motor based on information input from the automated driving control unit 270 or information input from the driving operator such that a brake torque based on a braking operation is output to vehicle wheels. The brake device 261 may include a mechanism for transmitting a hydraulic pressure generated by an operation of a brake pedal included in the driving operator to the cylinder via a master cylinder as a backup. The brake device 261 is not limited to the above-mentioned configuration, and may be an electronically controlled hydraulic brake device that controls an actuator based on information input from the automated driving control unit 270 such that the hydraulic pressure of the master cylinder is transmitted to the cylinder.

The steering device 262 includes, for example, a steering ECU and an electric motor. The electric motor changes a direction of turning wheels, for example, by applying a force to a rack-and-pinion mechanism. The steering ECU drives the electric motor based on information input from the automated driving control unit 270 or information input from the driving operator to change the direction of the turning wheels.

The door lock device 263 switches a door which is provided in the vehicle 200 between a locked state and an unlocked state. The door lock device 263 may include a mechanism for automatically opening and closing a door.

The vibrator 264 vibrates a seat which is provided in the vehicle 200 based on the control of the automated driving control unit 270. The vibrator 264 is realized, for example, by a mechanism (such as a motor) that rotates an eccentric rotor.

The seat driver 265 is driven to recline a seat which is provided in the vehicle 200 based on the control of the automated driving control unit 270 and changes a backrest position (angle), a seat position, or the like. The seat driver 265 is realized, for example, by an actuator.

The automated driving control unit 270 includes, for example, a route travel controller 272, a boarding/alighting position searcher 274, a user recognizer 276, a boarding/alighting controller 280, an HMI controller 290, a vibration controller 292, and a drive controller 294. The boarding/alighting controller 280 includes, for example, a stop/start controller 282 and a door lock controller 284. These constituents are realized, for example, by causing a hardware processor such as a central processing unit (CPU) to execute a program (software). Some or all of these constituents may be realized in hardware (a circuit unit; which includes circuitry) such as a large scale integration (LSI), an application specific integrated circuit (ASIC), a field-programmable gate array (FPGA), or a graphics processing unit (GPU) or may be realized in cooperation of software and hardware. The program may be stored in a storage device (for example, a storage device including a non-transitory storage medium) such as a hard disk drive (HDD) or a flash memory in advance, or the program may be stored in a removable storage medium such as a DVD or a CD-ROM and be installed in the storage device by inserting the storage medium into a drive device.

The route travel controller 272 controls the driving force output device 260, the brake device 261, and the steering device 262 such that the vehicle 200 travels along a designated route. Information on the route is received from the management device 300 by the communication device 220. The information on the route includes information of a boarding position or an alighting position for each user. The route travel controller 272 determines a recommended lane in which the vehicle 200 is to travel on the route, for example, by applying the route acquired from the management device 300 to high-precision map information. The high-precision map information is more precise than map information which is stored in the navigation device 230 and includes, for example, information such as a road width, a gradient, a curvature, and a position of a traffic sign for each lane. The recommended lane is a lane which is determined for a vehicle to travel efficiently on the route, for example, based on a reference for moves to a left lane before turning to left at a crossing or the like.

The route travel controller 272 causes the vehicle 200 to travel autonomously such that the vehicle 200 avoids interference with an object of which a position or a speed is input from the monitoring unit 210 while traveling on the recommended lane in principle. The route travel controller 272 generates a target trajectory on which the vehicle 200 will travel in the future. The target trajectory includes, for example, a speed element. For example, a target trajectory is expressed by sequentially arranging points (trajectory points) at which the vehicle 200 is to arrive. The trajectory points are points at which the vehicle 200 is to arrive at intervals of a predetermined traveling distance, and a target speed and a target acceleration at intervals of a predetermined sampling time (for example, several below the decimal point [sec]) are generated as a part of a target trajectory in addition. The trajectory points may be positions at which the vehicle 200 is to arrive at a sampling time every predetermined sampling time. In this case, information of the target speed or the target acceleration is expressed by intervals of the trajectory points. The boarding/alighting controller 280 also have the same function.

The boarding/alighting position searcher 274 searches for a stop position (a boarding/alighting position) at which the vehicle 200 can stop and a user can be picked up or alight out of boarding positions or alighting positions included in the information on the route acquired from the management device 300 with reference to information input from the monitoring unit 210, high-precision map information, or the like. The boarding/alighting position searcher 274 searches for and determines a boarding/alighting position based on white lines, yellow lines, and road markings on roads, road widths, or whether a walkway or a guard rail is present which can be recognized based on the information input from the monitoring unit 210.

The user recognizer 276 recognizes a user who is going to board the vehicle 200 based on the information input from the monitoring unit 210. The user recognizer 276 recognizes a user who is going to board the vehicle 200, for example, by inputting an image from a camera included in the monitoring unit 210 to a model which is trained by machine learning and which can determine a “user who is going to board the vehicle.”

The stop/start controller 282 of the boarding/alighting controller 280 performs deceleration control or steering control for causing the vehicle 200 to stop at the boarding/alighting position which is searched for and determined by the boarding/alighting position searcher 274 or performs deceleration control or steering control for causing the vehicle 200 to start at the boarding/alighting position to a roadway.

The door lock controller 284 switches a door lock of a predetermined door of the door lock device 263 to an unlocked state, for example, when the vehicle 200 stops at the boarding/alighting position and information indicating that authentication of a user has succeeded is acquired from the authentication device 242. The door lock controller 284 switches the door lock of the predetermined door of the door lock device 263 to a locked state before the stop/start controller 282 causes the vehicle 200 to start after the user boards the vehicle 200.

The HMI controller 290 controls the HMI 238 such that various types of information is output to a user or controls the HMI 238 or other devices such that an instruction from a user received by the HMI 238 is reflected.

For example, when the vehicle interior monitoring device 240 detects that a user in the vehicle 200 has not alighted at the scheduled alighting position, the HMI controller 290 causes the HMI 238 to perform a predetermined operation and urges a user who has not alighted at a scheduled alighting position to alight from the vehicle 200. Details of the predetermined operation will be described later.

For example, when the vehicle interior monitoring device 240 detects that a user in the vehicle 200 has not alighted at the scheduled alighting position, the vibration controller 292 causes the vibrator 264 to perform a predetermined operation and urges a user who has not alighted at a scheduled alighting position to alight from the vehicle 200. Details of the predetermined operation will be described later.

For example, when the vehicle interior monitoring device 240 detects that a user in the vehicle 200 has not alighted at the scheduled alighting position, the drive controller 294 causes the seat driver 265 to perform a predetermined operation and urges a user who has not alighted at a scheduled alighting position to alight from the vehicle 200. Details of the predetermined operation will be described later.

In the process of performing the predetermined operation, the HMI controller 290, the vibration controller 292, and the drive controller 294 are examples of an “operation controller.”

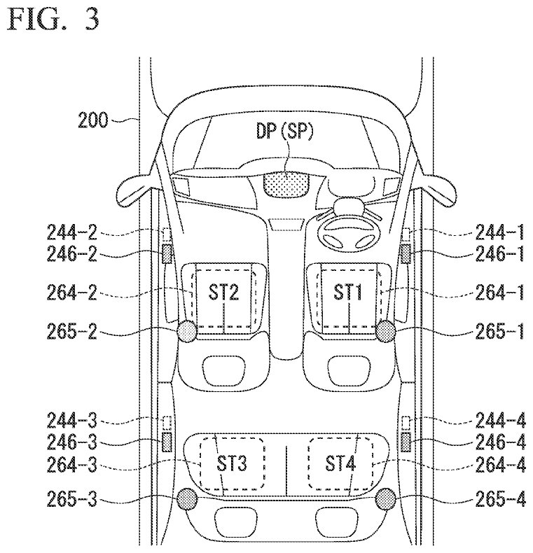

FIG. 3 is a diagram illustrating an example of a cabin when the vehicle 200 is seen from above. In the cabin in the example illustrated in the drawing, a display device DP of the HMI 238 is installed at the center of an instrument panel (between a driver's seat ST1 and a passenger's seat ST2). The display device DP may be provided at any position in the cabin as long as it can be seen from any users U who sit on the driver's seat ST1, the passenger's seat ST2, a rear seat ST3 provided behind the passenger's seat ST2, and a rear seat ST4 provided behind the driver's seat ST1. In FIG. 3, a speaker SP included in the HMI 238 is provided in the vicinity of the display device DP.

The exhalation detector 244 is provided in an intake port for inside air of an air conditioner (not illustrated) which is provided in the vehicle 200 and detects alcohol included in exhaled air of a user in the vehicle 200 by detecting alcohol included in the inside air of the cabin of the vehicle 200. In FIG. 3, exhalation detectors 244-1 to 244-4 that detect exhaled air of users who sit on the driver's seat ST1, the passenger's seat ST2, the rear seat ST3, and the rear seat ST4 are provided in the vicinity of the corresponding seats.

The alcohol detector 246 is provided in each door handle which is grasped by a user and detects an alcohol content of the user by allowing the user to grasp the door handle at the time of boarding the vehicle 200. In FIG. 3, alcohol detectors 246-1 to 246-4 that detect alcohol contents of users who sit on the driver's seat ST1, the passenger's seat ST2, the rear seat ST3, and the rear seat ST4 are provided in the corresponding door handles of the doors for the seats.

Vibrators 264-1 to 264-4 that vibrate the seat surfaces of the driver's seat ST1, the passenger's seat ST2, the rear seat ST3, and the rear seat ST4 are provided in the corresponding seats. In FIG. 3, seat drivers 265-1 to 265-4 that change backrest positions (angles), seat positions, and the like of the seats by reclining the seats are provided in the driver's seat ST1, the passenger's seat ST2, the rear seat ST3, and the rear seat ST4.

Management Device

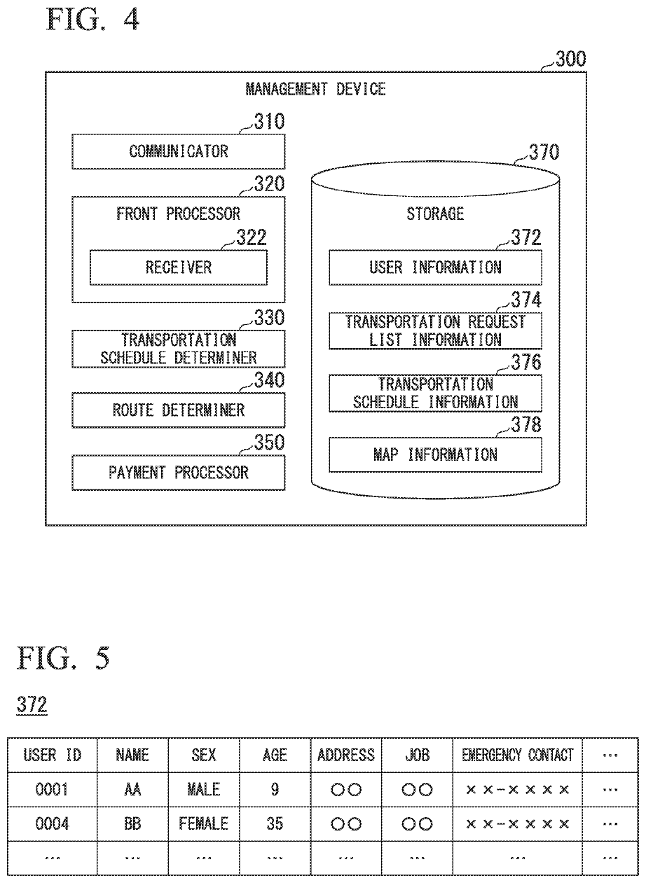

FIG. 4 is a diagram illustrating the configuration of the management device 300. For example, the management device 300 includes a communicator 310, a front processor 320, a transportation schedule determiner 330, a route determiner 340, and a payment processor 350. The front processor 320 includes a receiver 322. These constituents are realized, for example, by causing a hardware processor such as a CPU to execute a program (software). Some or all of the constituents may be realized by hardware (a circuit unit; which includes circuitry) such as an LSI, an ASIC, an FPGA, or a GPU, or may be realized by cooperation of software and hardware. The program may be stored in a storage device (a storage device including a non-transitory storage medium) such as an HDD or a flash memory in advance, or the program may be stored in a removable storage medium such as a DVD or a CD-ROM and installed in the storage device by inserting the storage medium into a drive device. The management device 300 may include a storage 370. The storage 370 is realized by a DVD, a random access memory (RAM), a flash memory, or the like. Information such as user information 372, transportation request list information 374, transportation schedule information 376, and map information 378 is stored in the storage 370.

FIG. 5 is a diagram illustrating an example of details of the user information 372. In the user information 372, for example, a name, a sex, an age, an address, a job, an emergency contact, and the like are correlated with a user ID which is identification information of each user. Each item of the user information 372 is registered in advance at the time of joining the service which is managed by the management device 300 or the like. The constituents of the management device 300 perform various processes with reference to the user information 372.

The communicator 310 is, for example, a network card for accessing a network NW. The communicator 310 communicates with a terminal device 100 or a vehicle 200 via the network NW.

The receiver 322 acquires a transportation request issued from a terminal device 100 of a user via the communicator 310 and registers the transportation request as the transportation request list information 374 in the storage 370.

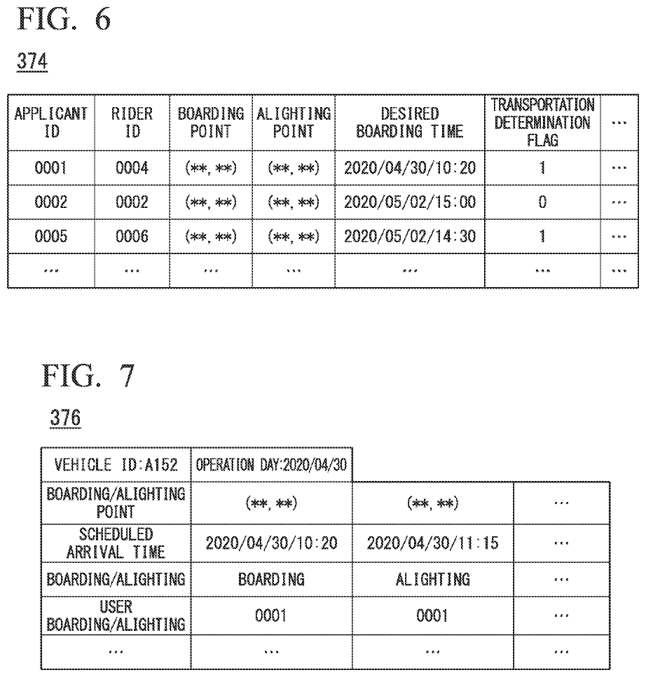

FIG. 6 is a diagram illustrating an example of details of the transportation request list information 374. In the transportation request list information 374, for example, information such as an applicant ID which is a user ID of a user (an applicant) having issued a transportation request, a passenger ID which is a user ID of a user (a passenger) in the vehicle 200, a boarding point which is a start point of a section associated with transportation, an alighting point which is an end point of the section, a desired boarding time, and a transportation determination flag (for example, “1” indicates that transportation is determined and “0” indicates that transportation is undetermined) indicating whether transportation has been determined by the transportation schedule determiner 330 is correlated with each other. A set of an applicant ID, a passenger ID, a guardian ID, a boarding point, an alighting point, a desired boarding time, and a transportation determination flag associated with one transportation request is called a record. The transportation request is information of an arbitrary format including details required to generate one record.

The transportation schedule determiner 330 determines a transportation schedule of a user using a vehicle 200 based on a record registered in the transportation request list information 374 and registers the transportation schedule in the transportation schedule information 376. FIG. 7 is a diagram illustrating an example of details of the transportation schedule information 376. The transportation schedule information 376 is generated, for example, for each vehicle ID which is identification information of a vehicle 200 which is used when there are a plurality of vehicles 200 and for each operation day. The transportation schedule information 376 is, for example, information in which boarding/alighting points, a scheduled arrival time, information indicating boarding or alighting, a user ID of a user who boards or alights from a vehicle, and the like are arranged in chronological order. The transportation schedule determiner 330 determines a scheduled arrival time in the case of boarding based on a desired boarding time of a record in the transportation request list information 374, and determines a scheduled arrival time in the case of alighting in consideration of information such as traffic information on that day and a speed limit.

The route determiner 340 determines a route which is instructed to a vehicle 200 based on the transportation schedule information 376 and the map information 378, and transmits information on the route to the vehicle 200 using the communicator 310. The route determiner 340 has the same function as an existing navigation system.

The payment processor 350 performs a process of collecting a fee from a user. For example, the payment processor 350 collects a fee from a user in cooperation with a management server of a credit card or digital cash.

Regarding Predetermined Operation

Details of the predetermined operations associated with the HMI controller 290, the vibration controller 292, and the drive controller 294 will be described below.

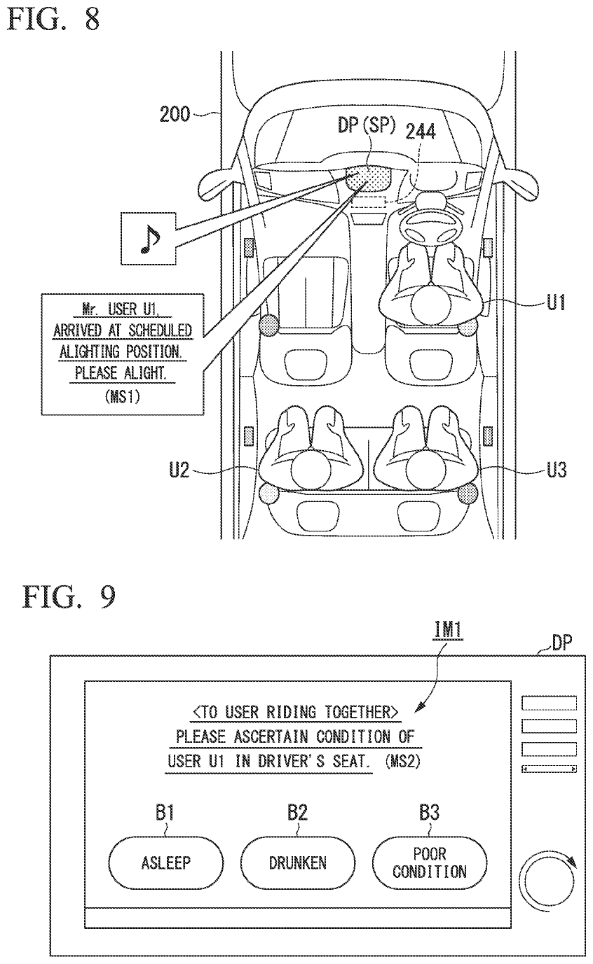

FIG. 8 is a diagram which is used to describe the predetermined operations associated with the HMI controller 290, the vibration controller 292, and the drive controller 294. For example, when the vehicle interior monitoring device 240 detects that a user in the vehicle 200 has not alighted at a scheduled alighting position, the HMI controller 290 causes a speaker SP of the HMI 238 to notify a user with a warning (an alarm) or to output a warning.

An alarm is, for example, a notification sound such as a buzzer or electronic sound. A warning is, for example, announcement voice for urging a user to alight. Details of the announcement are, for example, a message MS1 “Mr. User U1, the vehicle arrived at the scheduled alighting position. Please, alight.” When the details of the announcement include a name of a user U who is scheduled to alight at the scheduled alighting position, the HMI controller 290 identifies the name of the user U who is scheduled to alight with reference to the transportation schedule information 376 or the user information 372. The HMI 238 is an example of a “notifier” in the process of notifying a user with an alarm from the speaker SP, and is an example of a “sound output unit” in the process of outputting announcement voice from the speaker SP.

The announcement voice may be heard by another user in the vehicle 200 (a user U2 or a user U3 in the drawing). Accordingly, the announcement may include a nickname of the user U1 instead of the name of the user U1 in view of privacy protection of the user U1. In this case, a user may register a nickname along with (or instead of) a name at the time of joining the service which is managed by the management device 300, and the user information 372 may include the nickname of the user.

The announcement may include a seat position where the user U1 sits instead of (or in addition to) the name of the user U1. In this case, the details of announcement are, for example, a message “The vehicle has arrived at the scheduled alighting position. User sitting on a driver's seat, please alight.” When the details of announcement include the seat position of the user U1 who is scheduled to alight at the scheduled alighting position, the HMI controller 290 identifies the seat position where the user U1 scheduled to alight is sitting with reference to the transportation schedule information 376.

For example, when the vehicle interior monitoring device 240 detects that a user in the vehicle 200 has not alighted at the scheduled alighting position, the vibration controller 292 causes the vibrator 264 to vibrate. The vibration controller 292 identifies a seat where the user U1 scheduled to alight sits with reference to the transportation schedule information 376 or the user information 372 (the driver's seat ST1 in the drawing). The vibration controller 292 causes the vibrator 264 corresponding to the identified seat (the vibrator 264-1 in the drawing) and urges the user U1 having not alighted at the scheduled alighting position to alight from the vehicle 200.

The vibration controller 292 may cause the vibrator 264-1 to vibrate continuously, for example, until the vehicle interior monitoring device 240 detects that the user U1 scheduled to alight has alighted from the vehicle 200. The vibration controller 292 may control the vibrator 264-1 such that a degree of vibration increases as the elapsed time after the vibrator 264-1 has started vibration increases. The vibration controller 292 may cause the vibrator 264-1 to vibrate in a different mode of vibration at predetermined time intervals. Examples of the mode of vibration include continuous vibration, vibration with a predetermined rhythm, vibration with different strength, and combinations of such variations.

For example, when the vehicle interior monitoring device 240 detects that a user in the vehicle 200 has not alighted at the scheduled alighting position, the drive controller 294 drives the seat driver 265 to recline the seat. The drive controller 294 identifies a seat where the user U1 scheduled to alight sits with reference to the transportation schedule information 376 or the user information 372 (the driver's seat ST1 in the drawing). The drive controller 294 drives the seat driver 265 corresponding to the identified seat (the seat driver 265-1 in the drawing) and urges the user U1 having not alighted at the scheduled alighting position to alight from the vehicle 200.

The drive controller 294 may continuously drive the seat driver 265, for example, until the vehicle interior monitoring device 240 detects that the user U1 scheduled to alight has alighted from the vehicle 200. The drive controller 294 may control the seat driver 265-1 such that a degree of reclining increases as the elapsed time after the seat driver 265-1 has been driven increases. The drive controller 294 may drive the seat driver 265-1 in a different mode of driving at predetermined time intervals. Examples of the mode of driving include slow reclining, continuous change of a backrest position (angle), continuous change of a seat position, change of a driving speed, and combinations of such changes.

Regarding Condition of User

For example, when the vehicle interior monitoring device 240 detects that a user in the vehicle 200 has not alighted at a scheduled alighting position, the HMI controller 290 may cause the HMI 238 to notify another user of information for requesting the other user to ascertain the condition of the user U1 who has not alighted at the scheduled alighting position. FIG. 9 is a diagram illustrating an example of an image IM1 which is used to request another user to ascertain the condition of a user. The image IM1 includes, for example, a message MS2 for requesting another user to ascertain the condition of the user U1 who has not alighted at the scheduled alighting position and buttons B1 to B3 indicating choices of the condition of the user U1. The message MS2 is, for example, a message “<To user riding together> Please the condition of the user U1 on a driver's seat.” The choices of the condition of the user U1 are, for example, to select “asleep,” “drunken,” or “poor condition” as the condition of the user U1. The image IM1 is an example of “information which is used to request another user to ascertain the condition of a user.”

The HMI controller 290 causes the display device DP to display the image IM1. The HMI controller 290 identifies one choice of the condition of the user U1 selected by another user based on an operation which has been input to a touch panel of the display device DP by the other user in response to display of the image IM1 on the display device DP. In the process of displaying the image IM1 on the display device DP, the HMI 238 is an example of an “information notifier.”

The HMI controller 290 may output the message MS2 included in the image IM1 or the choice of the condition of a user U from the speaker SP by voice. In this case, the HMI controller 290 may auditorily recognize utterance details uttered from another user in response to outputting of voice from the speaker SP, and identify the choice selected by the other user.

The aforementioned choices are merely an example and the invention is not limited thereto. For example, the choices are not particularly limited as long as a state in which a user who has not alighted at a scheduled alighting position can alight immediately from the vehicle 200 or a state (condition) in which an immediate countermeasure is necessary can be selected. The state (condition) in which an immediate countermeasure is necessary is an example of a “predetermined state.”

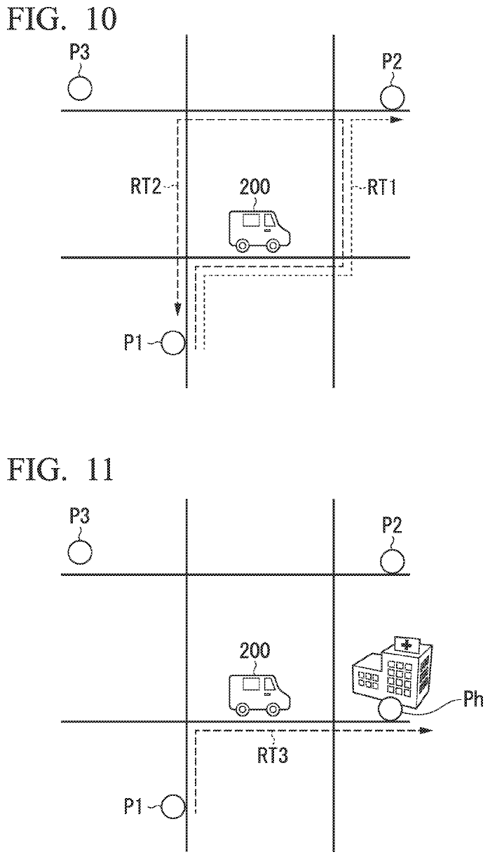

The route travel controller 272 requests the route determiner 340 to re-determine a route instructed to the vehicle 200 according to the condition of the user U1 identified by the exhalation detector 244, the alcohol detector 246, or the HMI controller 290. FIG. 10 is a diagram illustrating an example of a route RT2 which is re-determined by the route determiner 340. FIG. 11 is a diagram illustrating an example of a route RT3 which is re-determined by the route determiner 340. An operation in which the route travel controller 272 requests the route determiner 340 to re-determine a route and the route determiner 340 re-determines a route instructed to the vehicle 200 in response to the request is an example of a “predetermined operation.”

For example, when the aforementioned predetermined operation is performed by the HMI controller 290, the vibration controller 292, the drive controller 294, or the like and the vehicle interior monitoring device 240 detects that a user has not alighted at a scheduled alighting position, the route travel controller 272 requests the route determiner 340 to re-determine a route of the vehicle 200 based on the condition of the user U1. For example, the vehicle interior monitoring device 240 detects that the user has not alighted at the scheduled alighting position even if a predetermined time (for example, several [minutes] to several tens of [minutes]) has elapsed after the vehicle has arrived at the scheduled alighting position, the route travel controller 272 request redetermination of a route.

The route travel controller 272 requests redetermination of a route according to the condition of the user U1 indicated by the detection result from the exhalation detector 244, the condition of the user U1 indicated by the detection result from the alcohol detector 246, or the condition of the user U1 identified based on another user's operation of a touch panel by the HMI controller 290.

The route travel controller 272 may identify the condition of the user U1 based on at least one of the condition of the user U1 indicated by the detection result from the exhalation detector 244, the condition of the user U1 indicated by the detection result from the alcohol detector 246, or the condition of the user U1 identified based on another user's operation by the HMI controller 290. Priority levels may be allocated to the detection result from the exhalation detector 244, the detection result from the alcohol detector 246, and the identification result from the HMI controller 290, and the route travel controller 272 may identify the condition of the user U1 based on information with a higher priority level allocated thereto when a plurality of pieces of information is acquired. The exhalation detector 244 and the alcohol detector 246 are an example of a “condition detector.”

In the following description, the route travel controller 272 may perform a subsequent process using the condition of the user U1 based on another user's operation identified by the HMI controller 290 and perform a subsequent process using the condition of the user U1 based on the detection result from the exhalation detector 244 or the alcohol detector 246 when another user's operation cannot be acquired. The case in which another user's operation cannot be acquired includes, for example, a case in which there is no user riding together in the vehicle 200 or a case in which another user has not performed an operation.

In FIGS. 10 and 11, a position P1 indicates a scheduled alighting position of a user U1, a position P2 indicates a scheduled alighting position of a user U2, a position P3 indicates a scheduled alighting position of a user U3, and a position Ph indicates a position of a hospital near the vehicle 200. In FIGS. 10 and 11, a route RT1 indicates a route of the vehicle 200 which has been initially determined by the route determiner 340, and routes RT2 to RT3 indicate routes of the vehicle 200 which are re-determined according to the condition of the user U1 who has not alighted at the scheduled alighting position.

The route determiner 340 initially determines a route of the vehicle 200 such that the route passes through the positions P in the order of the position P1, the position P2, and the position P3 in the route RT1 determined based on the transportation schedule information 376. When it is detected that the user U has not alighted at the scheduled alighting position and the condition of the user U1 is not a state (condition) in which an immediate countermeasure is necessary, the route travel controller 272 requests the route determiner 340 to re-determine a route. In response to the request, the route determiner 340 determines a route RT2 in which the vehicle 200 first moves from the position P1 at which it is detected that the user U1 has not alighted to the scheduled alighting position (the position P2) of the user U2 and returns to the position P1 after movement to the position P2. The case in which the condition of a user is not a state (condition) in which an immediate countermeasure is necessary is, for example, a case in which the user U is simply asleep or merely drunken.

As illustrated in FIG. 10, the route RT2 is a route sequentially passing through the positions P in the order of the position P1 which is the scheduled alighting position of the user U1, the position P2 which is the scheduled alighting position of the user U2, the position P1, and the position P3 which is the scheduled alighting position of the user U3.

When it is detected that the user U1 has not alighted at the scheduled alighting position and the condition of the user U1 identified by the HMI controller 290 is a state (condition) in which an immediate countermeasure is necessary, the route travel controller 272 requests the route determiner 340 to re-determine a route. In response to this request, the route determiner 340 determines a route RT3 in which the vehicle 200 moves from the position P1 at which it is detected that the user U1 has not alighted to the position P3 of a hospital.

The processes after the route determiner 340 has determined the route RT2 or the route RT3 are the same as described above and thus description thereof will be omitted.

Operation Flow

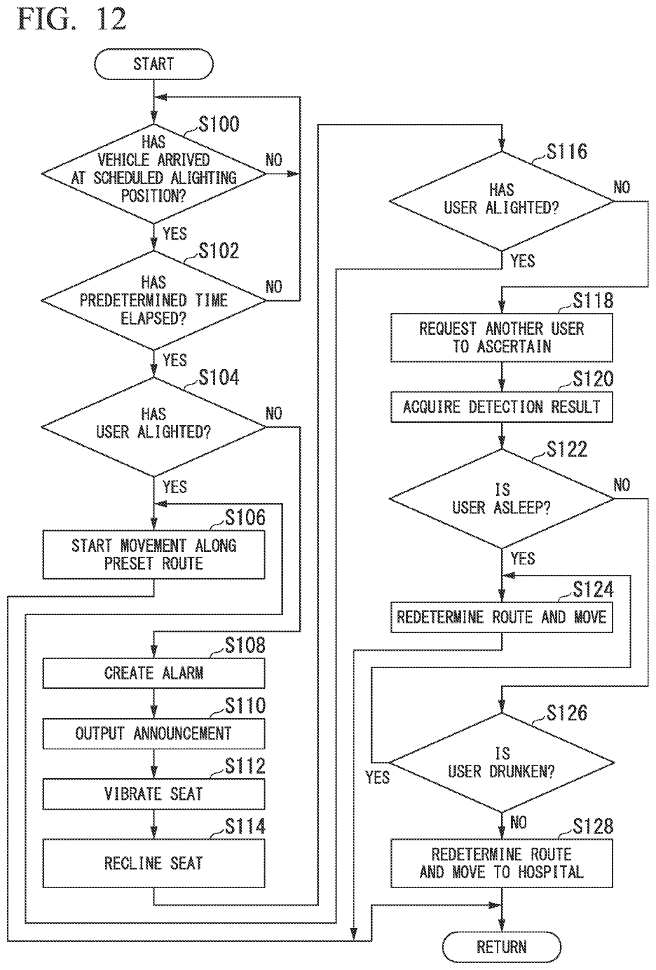

FIG. 12 is a flowchart illustrating a flow of a series of processes which are performed by the management device 300. First, the vehicle interior monitoring device 240 determines whether the vehicle 200 has arrived at a scheduled alighting position (Step S100). When it is determined that the vehicle 200 has arrived at the scheduled alighting position of a user, the vehicle interior monitoring device 240 determines whether a predetermined time has elapsed after the vehicle 200 has arrived at the scheduled alighting position (Step S102). The vehicle interior monitoring device 240 does not perform subsequent processes thereof but causes the flow to proceed to Step S100 until it is determined that the vehicle 200 has arrived at the scheduled alighting position of a user and until the predetermined time has elapsed after the vehicle 200 has arrived at the scheduled alighting position.

When it is determined that the vehicle 200 has arrived at the scheduled alighting position of the user and the predetermined time has elapsed after the arrival, the vehicle interior monitoring device 240 detects whether the user who is scheduled to alight at the scheduled alighting position has alighted from the vehicle 200 (Step S104). When the vehicle interior monitoring device 240 detects that the user has alighted from the vehicle 200, the route travel controller 272 starts movement of the vehicle 200 such that the vehicle 200 travels along a route RT1 designated in advance by the management device 300 (Step S106).

When the vehicle interior monitoring device 240 detects that a user in the vehicle 200 has not alighted at the scheduled alighting position, the HMI controller 290 causes the speaker SP of the HMI 238 to notify the user with an alarm (Step S108). Then, the HMI controller 290 causes the speaker SP of the HMI 238 to output announcement voice (Step S110).

Then, the vibration controller 292 causes the vibrator 264 to vibrate (Step S112). The vibration controller 292 identifies a seat on which the user scheduled to alight sits with reference to the transportation schedule information 376 or the user information 372. The vibration controller 292 causes the vibrator 264 corresponding to the identified seat to vibrate.

Then, the drive controller 294 drives the seat driver 265 to recline the seat (Step S114). The drive controller 294 identifies a seat on which the user scheduled to alight sits with reference to the transportation schedule information 376 or the user information 372. The drive controller 294 drives the seat driver 265 corresponding to the identified seat.

Then, the vehicle interior monitoring device 240 detects again whether the user scheduled to alight at the scheduled alighting position has alighted from the vehicle 200 (Step S116). When the vehicle interior monitoring device 240 detects that the user scheduled to alight at the scheduled alighting position has alighted from the vehicle 200, the route travel controller 272 starts movement of the vehicle 200 such that the vehicle 200 travels along the route RT1 designated in advance by the management device 300 (Step S106).

The vehicle 200 may perform one process of Steps S108 to S114. The vehicle 200 may perform a process of detecting whether the user scheduled to alight at the scheduled alighting position has alighted from the vehicle 200 again when each process of Steps S108 to S114 is performed. In this case, in the process of detecting whether the user has alighted, the vehicle 200 causes the flow of processes to proceed to Step S108 when it is detected that the user has alighted from the vehicle 200, and performs the subsequent processes of Steps S110 to S114 when it is detected that the user has not alighted.

When the vehicle interior monitoring device 240 detects that the user has not alighted from the vehicle 200, the HMI controller 290 notifies the HMI 238 of information for requesting another user to ascertain the condition of the user who has not alighted at the scheduled alighting position and identifies the condition of the user based on the other user's operation (Step S118). The HMI controller 290 causes the display device DP to display, for example, an image IM1. The HMI controller 290 identifies the choice for the condition of the user selected by the other user based on the other user's operation input to the touch panel of the display device DP in response to display of the image IM1 on the display device DP.

The route travel controller 272 acquires the detection results from the exhalation detector 244 and the alcohol detector 246 (Step S120).

The route travel controller 272 determines whether the condition of the user is a state in which the user is simply asleep based on the condition of the user indicated by the detection result from the exhalation detector 244, the condition of the user indicated by the detection result from the alcohol detector 246, or the condition of the user identified based on the other user's operation of the touch panel by the HMI controller 290 (Step S122). When it is determined that the condition of the user is a state in which the user is simply asleep (or when it is not ascertained whether the user is simply asleep from only the detection results), the route travel controller 272 requests the route determiner 340 to re-determine the route and controls the vehicle 200 such that the vehicle travels along the route RT2 determined by the route determiner 340 having received the request (Step S124). The route RT2 is, for example, a route along which the vehicle 200 first moves from the position P1 at which it is detected that the user U1 has not alighted to the scheduled alighting position (the position P2) of the next user U2 and returns to the position P1 at which it is detected that the user has not alighted after movement to the position P2.

When it is determined that the condition of the user is not a state in which the user is simply asleep, the route travel controller 272 determines whether the condition of the user is a state in which the user is simply drunken (a state other than a dead drunken state or a comatose state) based on the condition of the user identified based on the other user's operation of the touch panel by the HMI controller 290, the condition of the user indicated by the detection result from the exhalation detector 244, or the condition of the user indicated by the detection result from the alcohol detector 246 (Step S126). When it is determined that the condition of the user is a state in which the user is simply drunken, the route travel controller 272 causes the flow of processes to proceed to Step S124.

When it is determined that the condition of the user is not a state in which the user is simply asleep nor a state in which the user is simply drunken, the route travel controller 272 considers that the condition of the user is a state (condition) in which an immediate countermeasure is necessary, requests the route determiner 340 to re-determine the route, and controls the vehicle 200 such that the vehicle 200 travels along a route RT3 determined by the route determiner 340 having received the request (Step S128). The route RT3 is a route along which the vehicle 200 moves from the position P1 at which it is detected that the user has not alighted to a position P3 of a hospital.

As described above, the vehicle 200 according to this embodiment can appropriately cope with a user who has not alighted at a scheduled alighting position.

Another Example of Route RT2

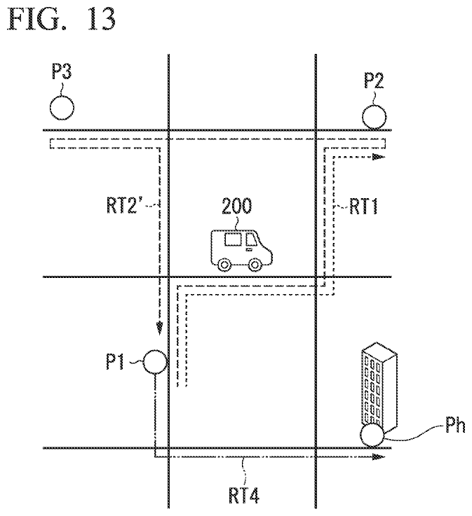

In the above description, in response to a request from the route travel controller 272, the route determiner 340 determines the route RT2 along which the vehicle 200 first moves from the position P1 at which it is detected that the user U1 has not alighted to the scheduled alighting position (position P2) of the next user U2 and returns to the position P1 at which it is detected that the user U1 has not alighted after movement to the position P2, but the invention is not limited thereto. For example, the route determiner 340 may determine a route RT2′ along which the vehicle 200 first moves to the scheduled alighting positions of all the other users in the vehicle 200 and finally moves to the scheduled alighting position of the user U1 who has not alighted at the scheduled alighting position. FIG. 13 is a diagram illustrating an example of a route RT2′ which is re-determined by the route determiner 340.

When it is detected that the user U1 has not alighted at the scheduled alighting position and the condition of the user U1 is not a state (condition) in which an immediate countermeasure is necessary, the route travel controller 272 requests the route determiner 340 to re-determine a route. In response to the request, the route determiner 340 determines a route RT2′ along which the vehicle 200 first moves from the position P1 at which it is detected that the user U1 has not alighted to a scheduled alighting position (position P2) of a user U2 who alights next and a scheduled alighting position (position P3) of a user U3 who alights next and returns to the position P1 at which it is detected that the user U1 has not alighted after movement to the position P3.

As illustrated in FIG. 13, the route RT2′ is a route passing through the positions P in the order of the position P1 which is the scheduled alighting position of the user U1, the position P2 which is the scheduled alighting position of the user U2, the position P3 which is the scheduled alighting position of the user P3, and the position P1 which is the scheduled alighting position of the user U1.

Accordingly, with the vehicle 200 according to this embodiment, even when there is a user who has not alighted at a scheduled alighting position, it can be prevented from affecting the alighting schedules of the other users.

Each user may register a final destination when the user would not have alighted at a scheduled alighting position at the time of joining the service that is managed by the management device 300. In this case, when it is detected that the user has not alighted at the scheduled alighting position and the condition of the user U is not a state (condition) in which an immediate countermeasure is necessary, the route travel controller 272 requests the route determiner 340 to re-determine a route. The route determiner 340 determines a route RT4 along which the vehicle 200 moves to the final destination which has been registered in advance by the user who has not alighted at the scheduled alighting position with reference to the user information 372 or the transportation schedule information 376.

As illustrated in FIG. 13, the route RT4 is a route along which the vehicle moves from the position P1 which is the scheduled alighting position of the user U1 to the final destination (a position Pf illustrated in the drawing) which was registered in advance by the user U1.

Accordingly, with the vehicle 200 according to this embodiment, it is possible to curb an increase in service fees due to the user U1 who has not alighted at the scheduled alighting position being unnecessarily continuously in the vehicle 200.

The above-mentioned embodiment can also be expressed as follows:

A management device that manages a service of transporting a user in a designated section using a vehicle which is able to travel autonomously without a driver by causing the vehicle to travel, the management device including:

a storage device configured to store a program; and

a hardware processor,

wherein the hardware processor executes the program to perform:
receiving a transportation request from a terminal device;
detecting whether a user in the vehicle has alighted at a scheduled alighting position of the user; and
causing the vehicle to perform a predetermined operation when it is detected that the user has not alighted at the scheduled alighting position.

While an embodiment of the invention has been described above, the invention is not limited to the embodiment and can be subjected to various modifications and replacements without departing from the gist of the invention.

For example, the management device 300 may be mounted in a vehicle 200. The vehicle 200 may be a remotely controlled vehicle which is remotely controlled from a remote place. In this case, the vehicle 200 transmits various types of information acquired by the monitoring unit 210 to an external device via the communication device 220. The external device generates (or reproduces) an image representing surrounding circumstances of the vehicle 200 based on the received information and presents the generated image to a remote operator. At this time, the image or the like may be corrected by a prediction process to cover a delay due to communication. The remote operator operates the driving operator based on the presented image. The operation performed on the driving operator is transmitted to the vehicle 200, and the vehicle 200 travels based on the received operation.

What is claimed is:

1. A management device that manages a service of transporting a user in a designated section using a vehicle which is able to travel autonomously without a driver by causing the vehicle to travel, the management device comprising:
a storage device configured to store a program; and
a hardware processor,
wherein the hardware processor executes the program to perform:
receiving a transportation request from a terminal device;
detecting whether a user in the vehicle has alighted at a scheduled alighting position of the user; and
causing the vehicle to perform a predetermined operation when it is detected that the user has not alighted at the scheduled alighting position.

2. The management device according to claim 1, wherein the hardware processor causes the vehicle to perform the predetermined operation when it is detected that the user has not alighted at the scheduled alighting position even if a predetermined time has elapsed after the vehicle has arrived at the scheduled alighting position.

3. The management device according to claim 1, further comprising a notifier configured to create an alarm,
wherein the predetermined operation includes creating an alarm to urge the user to alight, and
wherein the hardware processor causes the notifier to create an alarm.

4. The management device according to claim 1, further comprising a vibrator configured to vibrate a seat of the vehicle,
wherein the predetermined operation includes vibrating the seat to urge the user to alight, and
wherein the hardware processor causes the vibrator to vibrate the seat.

5. The management device according to claim 1, further comprising a sound output unit configured to output an announcement for urging the user to alight by voice,
wherein the predetermined operation includes outputting the announcement by voice to urge the user to alight, and
wherein the hardware processor causes the sound output unit to output the voice of announcement.

6. The management device according to claim 1, further comprising a driver configured to recline a seat of the vehicle,
wherein the predetermined operation includes reclining the seat to urge the user to alight, and
wherein the hardware processor causes the driver to recline the seat.

7. The management device according to claim 1, further comprising an information notifier configured to notify the user of the vehicle of information,
wherein the predetermined operation includes requesting another user to ascertain the condition of the user who has not alighted at the scheduled alighting position, and
wherein the hardware processor causes the information notifier to notify the other user of information which is used to request the other user to ascertain the condition of the user who has not alighted at the scheduled alighting position.

8. The management device according to claim 1, wherein the predetermined operation includes first moving to a scheduled alighting position of another user riding together in the vehicle and then moving to the scheduled alighting position of the user, and
wherein the hardware processor causes the vehicle to first move to the scheduled alighting position of the other user and then to move to the scheduled alighting position of the user.

9. The management device according to claim 1, wherein the predetermined operation includes first moving to scheduled alighting positions of all other user riding together in the vehicle and finally moving to the scheduled alighting position of the user, and
wherein the hardware processor causes the vehicle to first move to the scheduled alighting positions of all the other users and to finally move to the scheduled alighting position of the user.

10. The management device according to claim 1, wherein the predetermined operation includes moving to a predetermined final destination, and
wherein the hardware processor causes the vehicle to move to the final destination.

11. The management device according to claim 1, further comprising a condition detector configured to detect the condition of the user,
wherein the predetermined operation includes moving to a hospital according to the condition of the user, and
wherein the hardware processor causes the vehicle to move the hospital when the condition detector detects that the condition of the user is a predetermined state.

12. A management method that is performed by a computer, which realizes a management device that manages a service of transporting a user in a designated section using a vehicle which is able to travel autonomously without a driver by causing the vehicle to travel, the management method comprising:
receiving a transportation request from a terminal device;
detecting whether a user in the vehicle has alighted at a scheduled alighting position of the user; and
causing the vehicle to perform a predetermined operation when it is detected that the user has not alighted at the scheduled alighting position.

13. A computer-readable non-transitory storage medium having stored a program causing a computer, which for realizes a management device that manages a service of transporting a user in a designated section using a vehicle which is able to travel autonomously without a driver by causing the vehicle to travel, to perform:
receiving a transportation request from a terminal device;
detecting whether a user in the vehicle has alighted at a scheduled alighting position of the user; and
causing the vehicle to perform a predetermined operation when it is detected that the user has not alighted at the scheduled alighting position.
